(19) United States
(12) Patent Application Publication
(10) Pub. No.: US 2025/0257831 A1
(43) Pub. Date: Aug. 14, 2025

(54) Clamping Ring for a Fitting and Fitting With a Clamping Ring

(71) Applicant: Viega Technology GmbH & Co. KG, Attendorn (DE)

(72) Inventors: Fabian Düperthal, Lennestadt (DE); Paul Köster, Olpe (DE); Stefan Rocksloh, Attendorn (DE); Jürgen Krugmann, Meinerzhagen (DE)

(21) Appl. No.: 18/870,821

(22) PCT Filed: Jun. 19, 2023
(86) PCT No.: PCT/EP2023/066437

§ 371 Date: Dec. 2, 2024

(30) Foreign Application Priority Data
Jul. 5, 2022 (DE) 10 2022 116 679.1

(51) Int. Cl. F16L 37/091; F16L 37/084

(52) U.S. Cl. CPC F16L 37/091; F16L 37/0842

(57) ABSTRACT

A clamping ring for a fitting for a pipe which is to be sealed off from the exterior, including a plurality of ring elements and a plurality of hinge elements for pivotally connecting two respective ring elements. The ring elements are designed to hold and/or fix a pipe to be plugged in, the ring elements are strip-shaped by virtue of the hinge elements, and the ring elements can assume a flat shape or a laterally open annular shape. The clamping ring solves the techni-cal problem of providing a clamping ring with which the production of the clamping ring is simplified and which is designed to have a more flexible use. The invention also relates to a fitting including a clamping ring.

### CROSS-REFERENCE TO RELATED APPLICATIONS

This application is the United States national phase of International Patent Application No. PCT/EP2023/066437 filed Jun. 19, 2023, and claims priority to German Patent Application No. 10 2022 116 679.1 filed Jul. 5, 2022, the disclosures of which are hereby incorporated by reference in their entireties.

### BACKGROUND OF THE INVENTION

### Field of the Invention

The invention relates to a clamping ring for a fitting for a pipe to be sealed from the outside and a fitting for connection to a pipe to be sealed from the outside with a clamping ring.

The technical field relevant to the present invention is the on-site installation of pipework systems, in which a pipework system consisting of pipe sections and fittings is generally installed for the routing and guiding of a fluid, i.e. a liquid or a gas. A fitting is generally understood to be a connecting piece for a pipe, and a fitting is most frequently used to connect two or more pipe sections. Accordingly, the fitting preferably has two or more press sections, for example in the form of press sleeves. The most common fittings include straight connections, changes of direction in the form of pipe bends, reducers, branches such as T-pieces or crossings. However, a fitting also refers to a pipe connection for a fitting or other component. For example, thermometers or pressure gauges as fittings only have one connection for one pipe section. The fitting of a fitting therefore only has a press section to connect a pipe section to the fitting.

Press connections are used to connect the pipe sections to the fittings and other components, in which a press section of a fitting is formed radially inwards by means of a press jaw when the pipe section is inserted so that a permanent and tight, possibly even non-detachable connection is created. The fittings can be provided with a sealant, for example an O-ring, which ensures the tightness of the connection, or can also be formed by means of direct contact between the materials of the pipe section and the fitting, for example metal-to-metal sealing.

The press technology for radial forming of the press section is primarily radial press systems as well as press systems that utilise radial-axial pressing, whereby a part of the fitting is axially displaced during the pressing process in order to effect radial forming.

The piping systems generally described above are used in particular to transport drinking or heating water, gas for operating a heating system or industrial gases. In principle, any fluid medium can be transported in the pipework.

In the case of press fittings, a distinction is made as to whether a pipe is sealed and fixed from the outside during pressing or whether at least part of the fitting, for example in the form of a support sleeve, stabilises the pipe to be sealed from the inside. The present invention relates to the type of fitting in which the pipe is sealed and fixed from the outside. In principle, this does not rule out that a component of the fitting arranged inside the pipe is also arranged, but this is not usually the case.

### Description of Related Art

Solid materials, in particular metallic materials, are used as materials for pipes to be sealed from the outside. Solid plastics can also be used as solid materials. Suitable materials include, in particular, metals such as stainless steels like ferritic steels like 1.4520, 1.4521, austenitic steels like 1.4404, duplex steels like 1.4462, gunmetal, SiBr, copper, but also solid plastics such as cross-linked polyethylene (PE-X), polyethylene of increased temperature resistance (PE-RT), polyvinyl chloride (PVC) and polypropylene (PP) with corresponding wall thicknesses. Furthermore, multilayer composite pipes can be sufficiently rigid for sealing from the outside, for example with a thicker aluminium layer, and fibre-reinforced pipes can also be used.

The described fittings and their components are preferably made of a metal in order to ensure formability with sufficient hardness and dimensional stability after forming. The metals that can be used are those already mentioned for the rigid pipes, for example stainless steels such as ferritic steels like 1.4520, 1.4521, austenitic steels like 1.4404, duplex steels like 1.4462, gunmetal, SiBr, copper.

However, the described fittings and their components can also be made of a non-metallic material or plastic if the non-metallic material has sufficient properties for crimping and permanent connection to pipes. The following materials, for example, can be considered here: cross-linked polyethylene (PE-X), silane-cross-linked polyethylene (PE-Xb) or physically cross-linked polyethylene (PE-Xc), polyethylene with increased temperature resistance (PE-RT), polyvinyl chloride (PVC), polypropylene (PP) with corresponding wall thicknesses, polyphenylsulfone (PPSU), polyetheretherketone (PEEK) or polyaryletherketone (PAEK). Aliphatic bio-based polyamide (PA410, PA12, PA12-GF30) or polypropylene random copolymer with modified crystal structure and increased temperature resistance (PP-RCT).

Fittings for connecting to a pipe to be sealed from the outside can have various designs. As a rule, a sealing element, for example an O-ring, is provided to seal the fitting against the outside of the pipe. Furthermore, retaining elements and/or fixing elements are provided which fix the pipe in the required position relative to the fitting before and after pressing.

For example, a fitting for connecting to a pipe to be sealed from the outside has a base body with a structure with a stop element formed in the base body on the circumference and projecting inwards, with a press sleeve connected to the base body and forming an outer contour, the press sleeve having a chamber directed inwards towards the pipe to be received, with a clamping ring arranged in the chamber, the clamping ring consisting of a plastic and having a plurality of clamping elements aligned against the direction of extraction of the pipe to be inserted, and with a sealing element arranged in the chamber adjacent to the stop element, the clamping ring consisting of a plastic and having a plurality of clamping elements aligned against the direction of extraction of the pipe to be inserted, and with a sealing element arranged in the chamber adjacent to the stop element, wherein the clamping ring consists of a plastic and has a plurality of clamping elements aligned against the direction of extraction of the pipe to be inserted, and with a sealing element arranged in the chamber adjacent to the stop element, wherein the press sleeve is suitable, together with the clamping ring, the clamping elements and the sealing element, for sealing the rigid pipe to be connected from the outside.

The base body of the clamping ring is made of plastic and has a closed ring shape. In order to insert the clamping ring into a fitting or into the undercut chamber of the press sleeve, it must be compressed radially, for which purpose axially extending slots are provided that enable the compression.

The problem with the design of the fittings described above and the clamping rings used is that, on the one hand, a specific clamping ring has to be produced for each fitting. On the other hand, the production of the clamping rings is complex because retaining elements have to be formed and/or fixing elements integrated into the round mould and numerous slots have to be made in order to ensure formability for the installation. In addition, the arrangement of slots means that there is no continuous contact surface for the O-ring, which can shorten the service life of the connection.

U.S. Pat. No. 4,119,335 A describes a clamping ring arrangement in the form of an elongated strip with knurled ring elements that are connected to each other by elastomer elements.

EP 3 051 199 A1 describes a clamping ring arrangement in the form of a ring with ring elements that are connected to each other by means of connecting elements.

EP 2 242 947 A1 describes a clamping ring with ring elements, which can be in strip form or as a laterally open ring.

US 2016/053783A1 describes a retaining clip in the form of a band with ring elements and hinge elements and a locking mechanism that can be used to secure the connection points of pipelines.

JP 2014 190366 A describes a fitting for connecting pipes with a retaining element with ring elements and hinge elements made of different materials.

### SUMMARY OF THE INVENTION

The present invention is therefore based on the technical problem of providing a clamping ring and a fitting with such a clamping ring, whereby the manufacture of the clamping ring is simplified and its use is made more flexible.

The above technical problem is solved according to the invention by a clamping ring for a fitting for a pipe to be sealed from the outside with a plurality of ring elements and with a plurality of hinge elements for pivotable connection of two ring elements in each case, wherein the ring elements are designed for holding and/or fixing a pipe to be inserted, wherein the ring elements have a strip shape by means of the hinge elements and wherein the ring elements can assume a flat shape or a laterally open ring shape and wherein the ring elements have lateral surfaces in the azimuthal direction, which are designed to taper inwards towards each other at least in sections in the radial direction.

The technical problem described above is also solved according to the invention by a fitting for connection to a pipe to be sealed from the outside, with a base body, with a stop element formed in the base body on the circumference and projecting inwards, with a press sleeve connected to the base body, the press sleeve having a chamber directed inwards towards the pipe to be received, with a clamping ring arranged in the chamber, the clamping ring consisting of a plastic and having a plurality of cutting elements aligned against the direction of extraction of the pipe to be inserted, and with a sealing element arranged in the chamber adjacent to the stop element, wherein the press sleeve is suitable, together with the clamping ring, the cutting elements and the sealing element, for sealing the pipe to be connected from the outside, wherein the clamping ring is designed in one of the embodiments described above and below.

The clamping ring is advantageously manufactured as a flat product, whereby the individual ring elements are movably connected to each other by means of the hinge elements. The ring elements thus form individual segments of the press ring. The term “flat product” or “flat” means that the ring elements can be brought into an elongated, flat and strip-like shape by the hinge elements and the ring elements can lie essentially flat on a surface.

The hinge elements are preferably designed as film hinges integral with the ring elements, so that the clamping ring has a one-piece basic shape. The clamping ring can therefore preferably be produced as an endless profile using a plastic extrusion process. The design as a flat strip-shaped clamping ring also facilitates the assembly of additional elements such as cutting elements, which can be integrated more easily after the strip has been manufactured than if the clamping ring is in ring form.

The ring elements connected to each other by means of the hinge elements can be folded from a flat shape into a ring shape. For installation in a fitting, the clamping ring is therefore cut to a predetermined length and then inserted into the fitting in an open ring shape, similar to a C-shape. For installation, the shape of the clamping ring can be slightly reshaped radially inwards due to the special design with the hinge elements and the associated special elasticity. If necessary, the free ends of the clamping ring can overlap during installation and unfold into a ring shape when inserted into the chamber of the press sleeve. This makes installation easier, particularly in fittings with small diameters.

When the fitting is pressed radially using a pressing tool, the hinge elements and the neighbouring areas of the ring elements form the deformation zones. The deformation zones are therefore evenly and possibly even symmetrically distributed in the circumferential direction. During the pressing process, the deformation zones then ensure a uniform application of force in the azimuthal direction and, in particular, tangential displacement of the ring elements is limited or even completely avoided. Particularly in the design of the ring element as a fixing element with cutting element described below, it is advantageous that tangential movement of the cutting element is restricted or avoided.

In addition, the compressed hinge elements together with the ring elements create a continuous sealing contact surface in the pressed state, which facilitates the positioning and securing of the sealing element.

The ring elements described above are preferably made of one of the following materials: cross-linked polyethylene (PE-X), silane-cross-linked polyethylene (PE-Xb) or physically cross-linked polyethylene (PE-Xc), polypropylene (PP), polyphenylsulfone (PPSU), polyetheretherketone (PEEK) or polyaryletherketone (PAEK), aliphatic bio-based polyamide (PA410, PA12, PA12-GF30) or polypropylene random copolymer with modified crystal structure and increased temperature resistance (PP-RCT).

In a preferred manner, the ring elements have a partially cylindrical outer surface. This means that the ring elements adapt to the cylindrical shape of the fitting in the area of the chamber of the press sleeve, at least in sections on the outside. In the flat strip-like shape, the ring elements can therefore rest on a flat surface with a section of their partially cylindrical outer surface.

Furthermore, the ring elements have lateral surfaces in the azimuthal direction that are tapered inwards towards each other in at least some sections in the radial direction. This allows the ring elements together with the hinge element connecting them to form a V-groove between them. This V-groove allows for an easier circular arrangement of the ring elements. Furthermore, an additional space between the ring elements provides a volume that can be filled with material from the ring elements during pressing. This leads to an even distribution of the pressing force, which is permanently exerted by the press sleeve via the clamping ring on the outside of the pipe.

In a further preferred manner, the ring elements have a predetermined azimuthal length, so that by cutting the strip of hinge elements into strips with at least two different numbers of ring elements for at least two clamping rings for fittings with at least two different standard widths is possible. This means that the clamping ring can be used in different nominal widths by cutting it to different lengths. Since the clamping ring should preferably fill a full circle within the fitting, firstly to ensure a continuous contact surface for the sealing element and secondly to ensure a tight fit of the clamping ring before pressing, for example to prevent it from falling out during transport.

To enable the multiple use of a clamping ring described above, the clamping ring pitch is selected so that the full circumference can be achieved with two or more nominal widths.

Furthermore, the ring elements can have a seal seat at the end facing a seal to be inserted. The seal seat is preferably realised by an axially protruding retaining element, which limits the space spanned by the ring element radially inwards and thereby restricts the freedom of movement of the seal. However, the ring element can also be round in section and restrict the freedom of movement of the seal solely through axial contact with the seal.

On the one hand, the seal seat improves seal protection by restricting or preventing the seal from being pressed out in an axial direction when the fitting is pressed. On the other hand, the seal seat prevents the seal from being pushed out by axial forces during pipe insertion. In addition, the position of the seal is also secured against displacement in the unpressed state in the event of pressure differences if the seal is sucked in in the axial direction due to pressure differences.

The ring elements of the clamping ring can fulfil the same or different functions and therefore have different designs. The different functions can be realised alternately or otherwise alternately by the adjacent ring elements.

In a first preferred embodiment, the ring elements are at least partially designed as retaining elements and the retaining elements have radially inwardly directed, preferably elastically designed, guiding elements for centring and, if necessary, retaining a pipe to be inserted. Thus, the retaining elements serve on the one hand to centre the pipe when the pipe is inserted into a fitting and the clamping ring arranged therein and on the other hand to hold the pipe with defined assembly forces after insertion and before the fitting is pressed.

The centring of the pipe during insertion into the fitting is also preferably improved by the fact that at least two guiding elements projecting radially inwards to different extents are formed one behind the other in the axial direction. This results in a first centring and a second centring one after the other during the insertion of the pipe. The first guiding element, which is distal from the fitting, can project less inwards than the proximal guiding element, so that good guidance to the correct position for pressing is achieved, particularly for pipes inserted at an angle. In addition, the various guiding elements hold the inserted pipe after assembly and before pressing.

The design of the guiding elements leads to defined assembly forces and therefore also to improved haptic control when inserting a pipe into the fitting, especially with a two-stage design of two guiding elements that protrude inwards at different distances. The user can check more precisely by touch whether the pipe has been inserted correctly and far enough.

Thanks to the geometry of the guiding elements with defined material thickness and material properties, a consistent assembly and pipe holding force can be realised regardless of the tolerances of the pipe.

Due to the centring function, in particular together with the seal seat described above for more precise positioning of the seal, the guiding elements ensure that the outer surface of the pipe only comes into contact with the inside of the seal to a small extent or preferably not at all during insertion of the pipe. This reduces the risk of damage to the seal and low insertion forces can be realised even without the use of lubricants such as silicone oil. The use of gaskets without paint wetting impairment substances (LABS-free) and without silicone is therefore possible.

The functionality of an intentionally leaking arrangement of pipe and seal in the uncompressed state is also improved by the design described, as the positioning and holding of the pipe relative to the seal is improved. If, for example, the seal has a sufficiently larger internal diameter than the external diameter of the pipe, an intended leak in the unpressed state can be achieved and ensured.

As an alternative to the retaining elements, the ring elements can also be designed at least partially as fixing elements, whereby the fixing elements each have at least one cutting element for fixing a pipe to be inserted. After the fitting has been pushed in and pressed, the pipe is secured by the fixing elements to prevent the pipe from being pulled out of the fitting.

In a preferred manner, the cutting elements lie on the inside of the pipe along a linear area, in particular a cutting edge, and on the outside of the chamber of the press sleeve along a flat area. This means that when the fitting is pressed, the radially inward force can be effectively used to cut the cutting element into the wall of the pipe.

In a preferred design of the clamping ring, the fixing elements have protective elements arranged next to the cutting elements in the circumferential direction, with the protective elements projecting further inwards in the radial direction than the cutting elements. This protects the pipe from contact with the cutting elements during insertion and before pressing and largely prevents damage to the surface of the pipe in unwanted places. The protective elements therefore have a similar effect to the guiding elements described above.

In a particularly preferred manner, the clamping ring is designed with both retaining elements and fixing elements, so that some of the ring elements are designed as retaining elements and some of the ring elements are designed as fixing elements. Preferably, the retaining elements and the fixing elements are equally distributed around the circumference in order to achieve as symmetrical an arrangement as possible.

It is also preferred that the number of retaining elements is greater than or equal to the number of fixing elements, in particular the ratio of retaining elements to fixing elements is 1:1 or 2:1. A larger number of fixing elements is also possible, whereby only 3-5 retaining elements and otherwise only fixing elements are provided.

The previously described guiding elements of the retaining elements and the protective elements of the fixing elements can contribute to fixing in addition to the cutting elements by also penetrating the pipe wall during pressing. This means that the number of fixing elements can be smaller than the number of retaining elements.

### BRIEF DESCRIPTION OF THE DRAWINGS

In the following, the invention is explained with reference to the drawing by means of examples of embodiments. The drawing shows

FIGS. 1a-4b a first example of a clamping ring according to the invention,

FIGS. 5a-8b a second example of a clamping ring according to the invention and

FIGS. 9a-9c an example of a fitting with inserted clamping ring without and with inserted pipe,

FIGS. 10a-10b a schematic representation of a fitting with a fitting according to the invention before and after radial crimping.

### DESCRIPTION OF THE INVENTION

In the following description of the various embodiments according to the invention, components and elements with the same function and the same mode of operation are provided with the same reference symbols, even if the components and elements may differ in their dimensions or shape in the various embodiments.

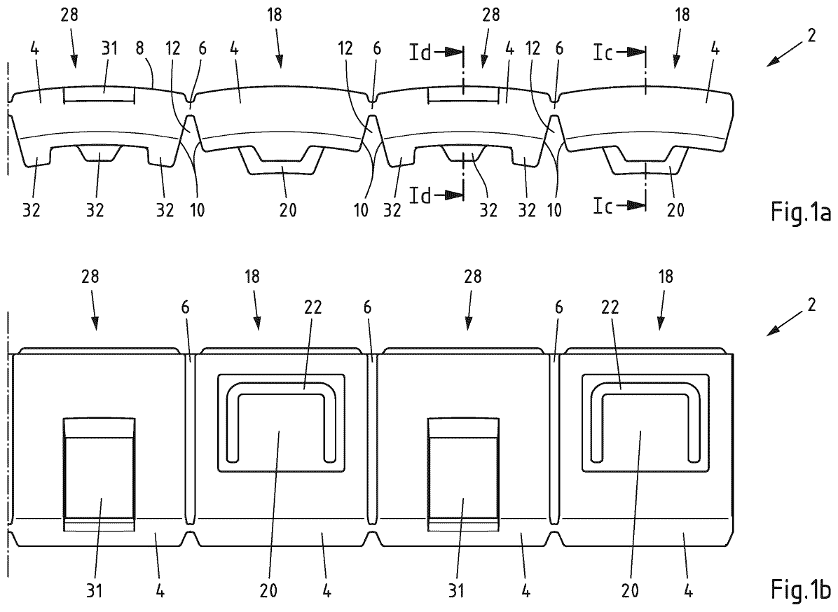

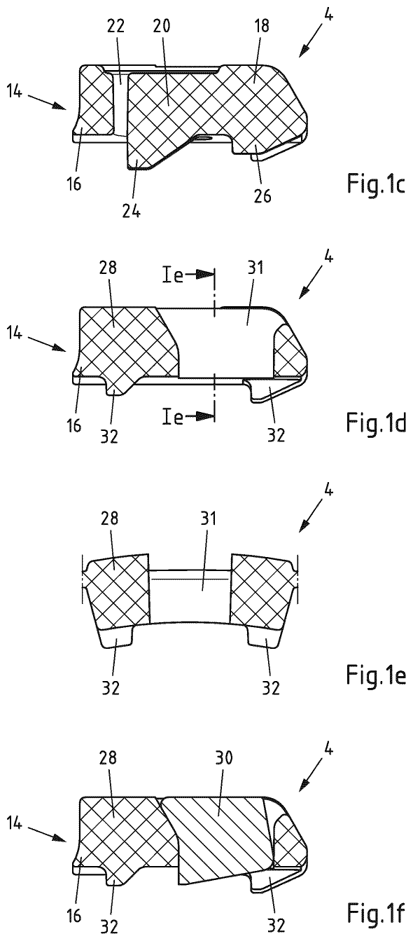

FIGS. 1a to 4b show a first example of a clamping ring 2 in various views and positions.

The clamping ring 2 is suitable for a fitting for a pipe to be sealed from the outside, which is described below. The clamping ring 2 has a plurality of ring elements 4, each of which is pivotably connected to one another with hinge elements 6. The ring elements 4 are used to hold and/or fix a pipe to be inserted.

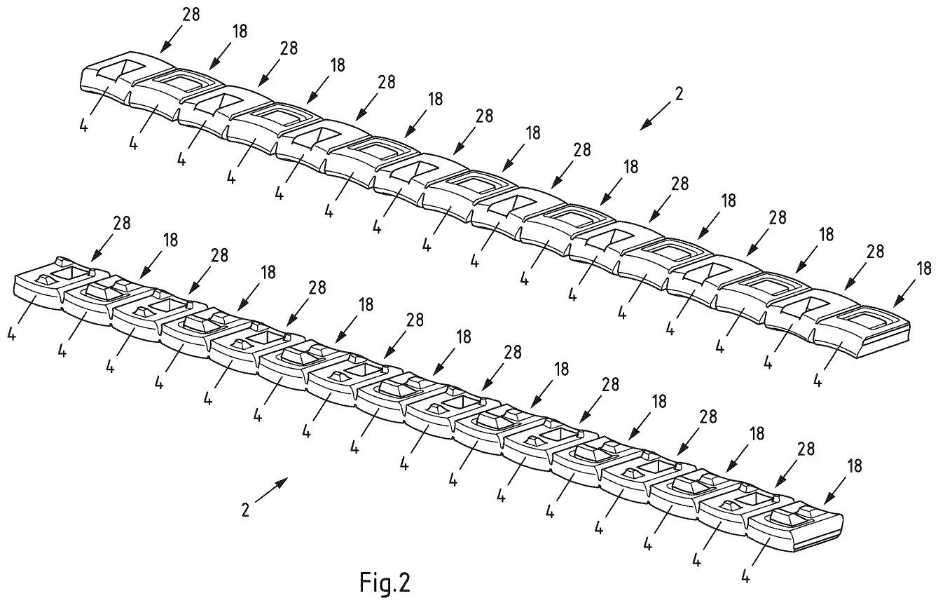

Furthermore, the ring elements 4 have a strip shape by means of the hinge elements 6, as can be seen in particular from FIGS. 1a and 2. The ring elements 4 can therefore assume a flat shape as in FIGS. 1a and 2, whereby “flat” essentially means that the ring elements 4 can rest on a surface.

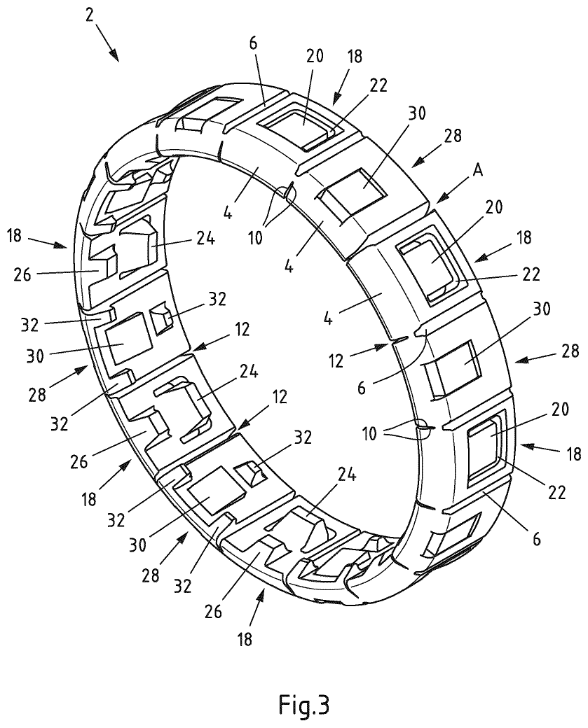

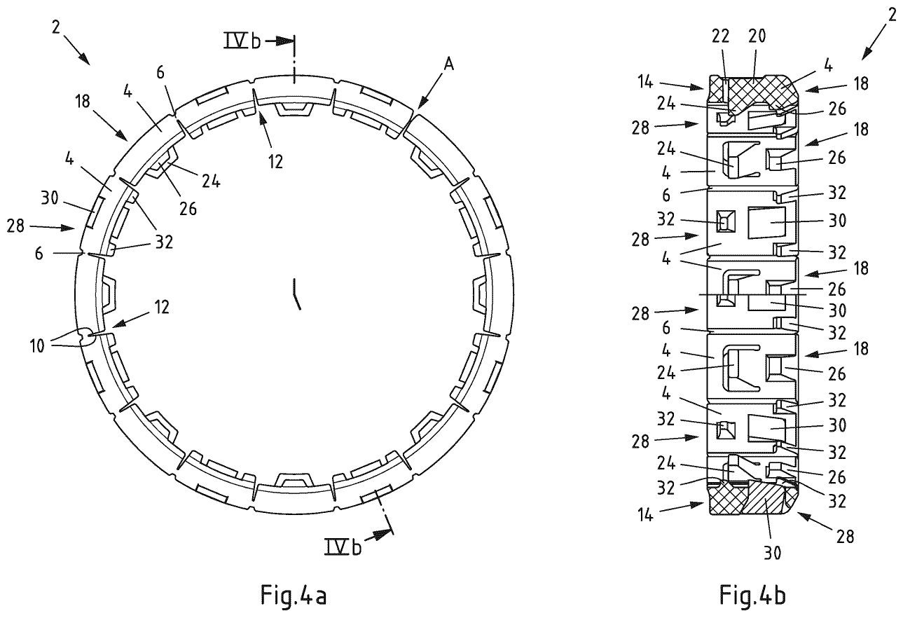

On the other hand, the ring elements 4 can also assume a laterally open ring shape by means of the hinge elements 6, as shown in FIGS. 3, 4a and 4b. In the ring shape, the clamping ring 2 has a C-shape that is open on one side.

During the manufacture of the clamping ring 2 as a continuous product, for example as a product of a plastic extrusion process, the flat arrangement has the advantage that the ring elements 4 can be easily fitted with further elements without a ring mould leading to complex process steps.

As can be seen from FIGS. 1a to 4b, the ring elements 4 have a partially cylindrical outer surface 8, which is adapted to the cylindrical shape of the fitting or the chamber of the associated press sleeve. This allows the clamping ring to lie flat against the fitting, at least in sections. In the flat shape of the clamping ring 2, the partially cylindrical outer surfaces then rest on a base in sections.

Furthermore, the ring elements 4 have lateral surfaces 10 in the azimuthal direction, which are tapered inwards towards each other at least in sections in the radial direction. As a result, V-grooves 12 are formed between the ring elements 4 together with the hinge element 6. In FIG. 1a, the V-grooves 12 in the elongated flat shape of the clamping ring 2 are relatively wide, while in FIG. 4a, the V-grooves 12 in the curved ring shape of the clamping ring 2 are narrower, but still present.

The ring elements 4 also have a predetermined azimuthal length, so that the strip of hinge elements 6 can be cut into strips with at least two different numbers of ring elements 4 for at least two clamping rings 2 for fittings with at least two different standard widths. In this way, sections of different lengths can be cut from the endlessly produced strand as clamping ring 2, which are then suitable in bent form for fittings with different nominal widths. This feature is particularly advantageous with regard to the efficiency of the production process.

The following values are given as a possible example:
Nominal diameter NW28: Inner diameter D=35 mm and circumference=109.96 mm (equal to the length of the clamping ring)
Nominal diameter NW35: inner diameter D=42 mm and circumference=131.95 mm (equal to the length of the clamping ring)
With a ring element length of 11 mm, this means that 10 elements=110 mm can be used for nominal width NW28 and 12 elements=132 mm for nominal width NW35.

The ring elements 4 also have a seal seat 14 at the end facing a seal to be inserted, which is formed by an axially protruding retaining element 16. The seal seat 14 secures the position of the seal within a fitting both before and after the fitting is pressed.

As can be seen directly from FIG. 1a, the ring elements 4 are designed differently.

On the one hand, the ring elements 4 are partially designed as retaining elements 18 and have radially inwardly directed elastic guiding elements 20 for centring and, if necessary, holding a pipe to be inserted. The guiding elements 20 are designed in such a way that defined assembly forces and an improved pipe holding function are achieved.

According to FIGS. 1a and 1b, the guiding elements 20 are machined out of the material of the retaining element 18 by means of a recess 22 extending on three sides and are thus designed to be elastically resilient. Directed radially inwards, the guiding elements 20 have protruding wedges 24, which lie against the pipe to be inserted and guide it, as can be seen in FIG. 1c.

Guiding elements 26 projecting less radially inwards are formed offset in the axial direction to the guiding element 20. This means that when a pipe is inserted (coming from the right in FIG. 1c), a first centring is performed by the guiding element 26 and a second centring by the guiding element 20 with the wedge 24 or wedges 24. In particular, pipes placed at an angle are centred and optimally arranged in the fitting by these differently pronounced guides. The distal guiding element 26 therefore protrudes less inwards than the proximal guiding element 20 as seen from the fitting. When the pipe is fully inserted, the guiding elements 20 and 26 hold the inserted pipe.

As an alternative to the retaining elements 18, a further part of the ring elements 4 are designed as fixing elements 28 and each have at least one cutting element 30 for fixing a pipe to be inserted, as shown in FIG. 1f. For this purpose, the fixing element 28 has a recess 31 shown in FIGS. 1a, 1b, 1d and 1e, into which the cutting element 30 is inserted. In FIGS. 1a, 1b, 1d and 1e, the fixing element 28 is shown without cutting element 30 and in FIG. 1f with cutting element 30. The cutting element 30 is preferably made of metal and fixes an inserted pipe after pressing before the pipe is pulled out of the fitting.

The fixing elements 28 shown also have protective elements 32 arranged in the circumferential direction next to the cutting element 30, which project further inwards in the radial direction than the cutting elements 30. The protective elements 32 thus protect the pipe during insertion and against unintentional damage to the surface during pressing.

As can be seen from FIGS. 1a and 1b as well as 2 to 4a and 4b, some of the ring elements 4 are designed as retaining elements 18 and some of the ring elements 4 are designed as fixing elements 28. The retaining elements 18 and the fixing elements 28 alternate with one another so that they are evenly distributed around the circumference. In this embodiment example, the number of retaining elements 18 is equal to the number of fixing elements 28.

As shown in FIGS. 3 and 4a, the strip of the clamping ring 2 is bent into a round clamping ring 2, with its side ends forming an open point at the location marked with the arrow A.

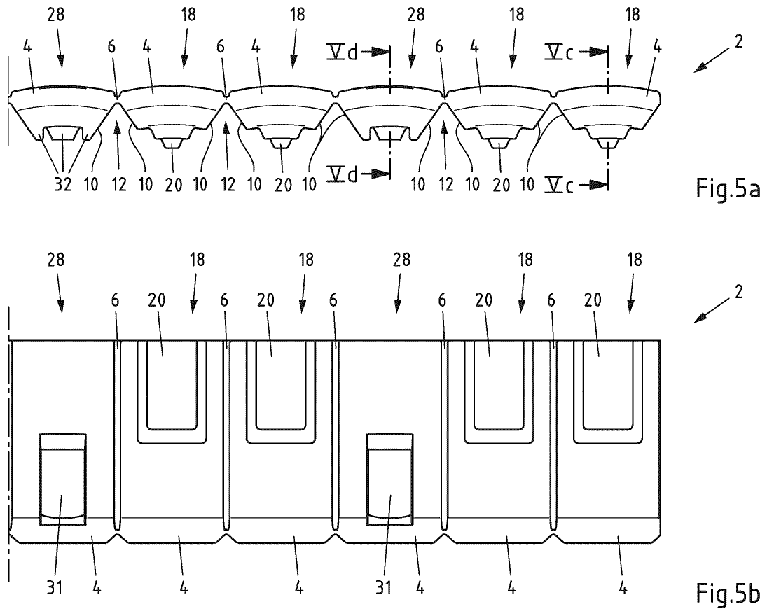

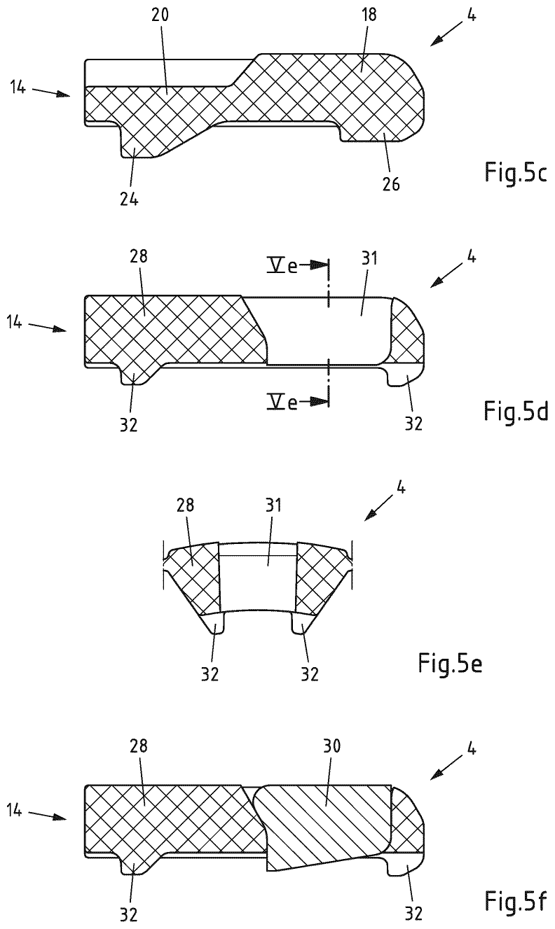

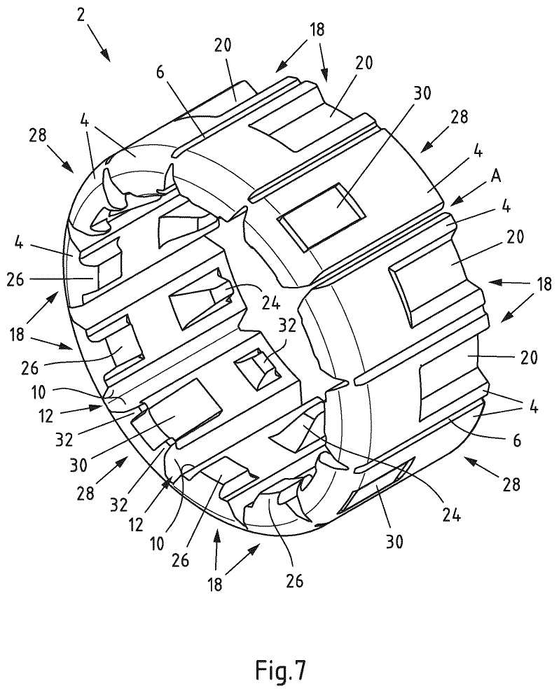

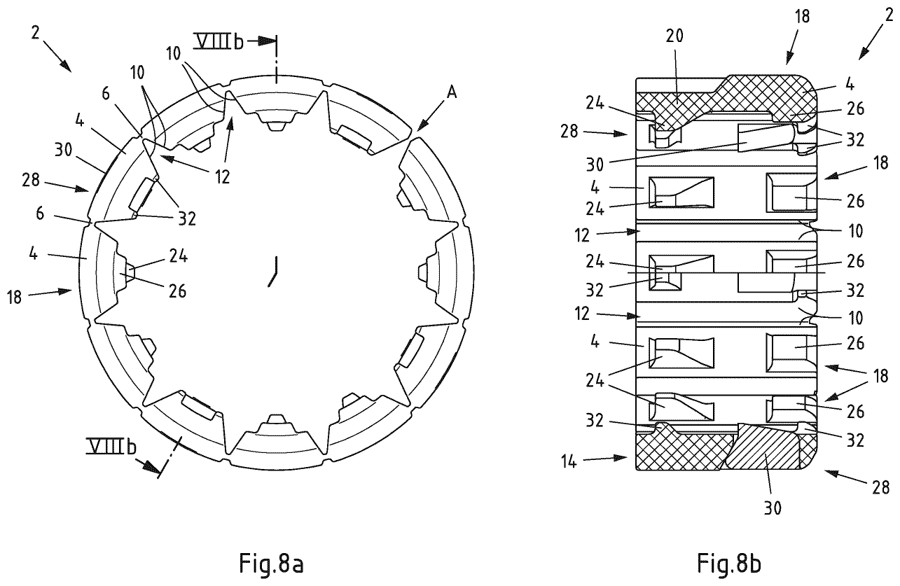

FIGS. 5a to 5f and 6 to 8a and 8b show a second design example which, in contrast to the first design example, is designed for smaller nominal diameters of the pipes to be connected. The individual ring elements 4 are therefore smaller in size, but have the same or identical functionalities.

Therefore, only the differences are explained below and reference is otherwise made to the description of the first embodiment example.

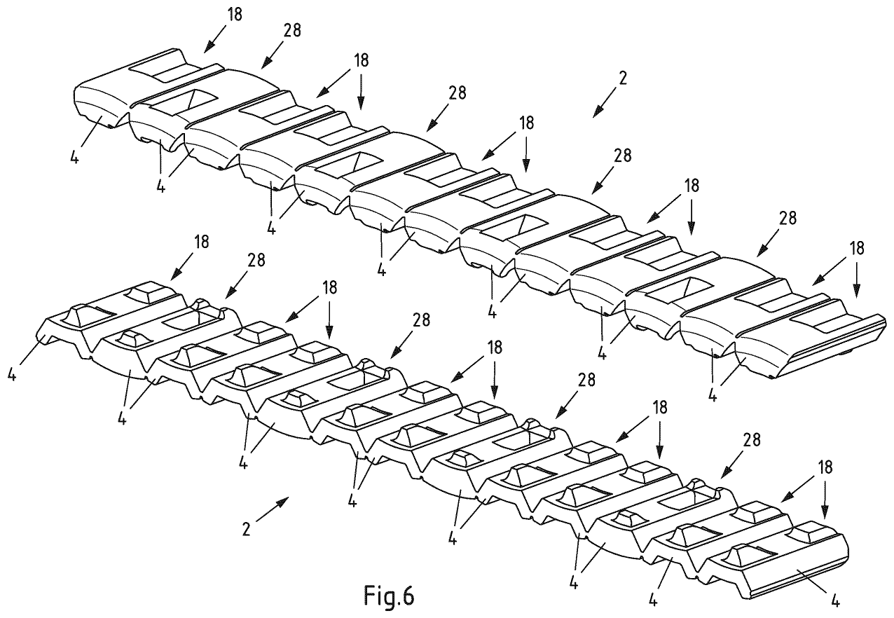

FIG. 6 shows the flat clamping ring 2, which has twice as many retaining elements 18 as fixing elements 28. The sequence is therefore two retaining elements 18 and one fixing element 28. This design has proven to be advantageous for smaller nominal diameters, as fewer pull-out forces have to be compensated for by the fixing elements 28 than is the case with the first design example for larger nominal diameters.

As can also be seen from FIGS. 5b and 5c, the guiding element 20 is not exposed, but the elasticity of the guiding element 20 is adjusted and ensured by reducing the material through a recess 25.

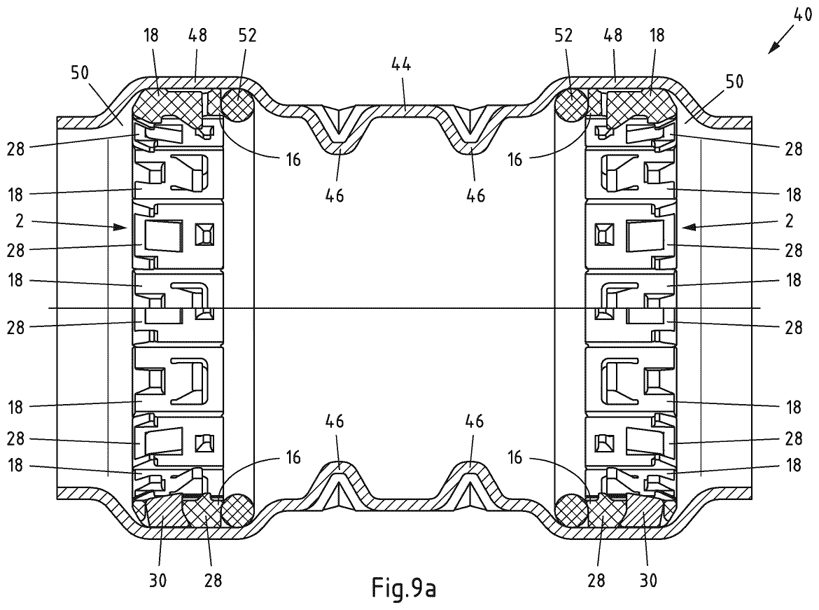

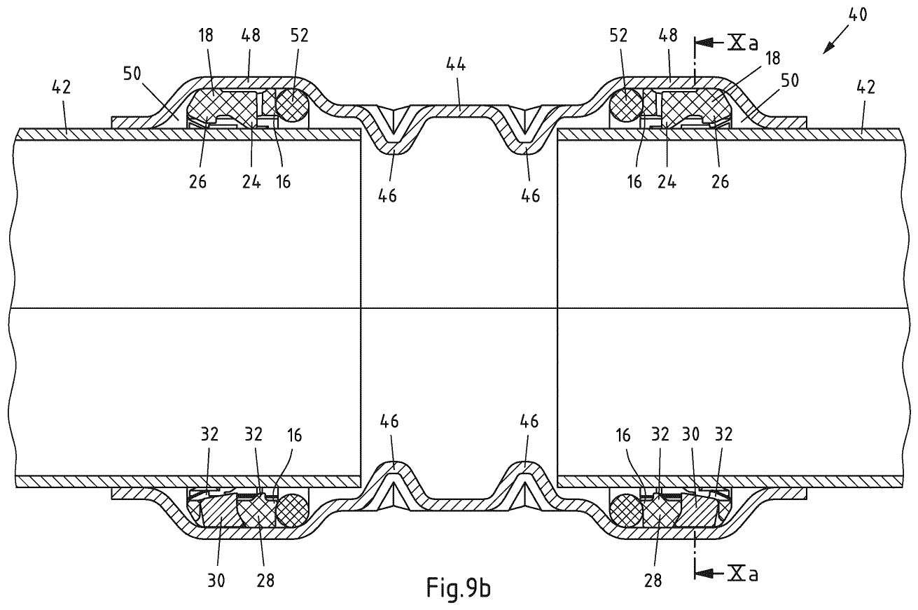

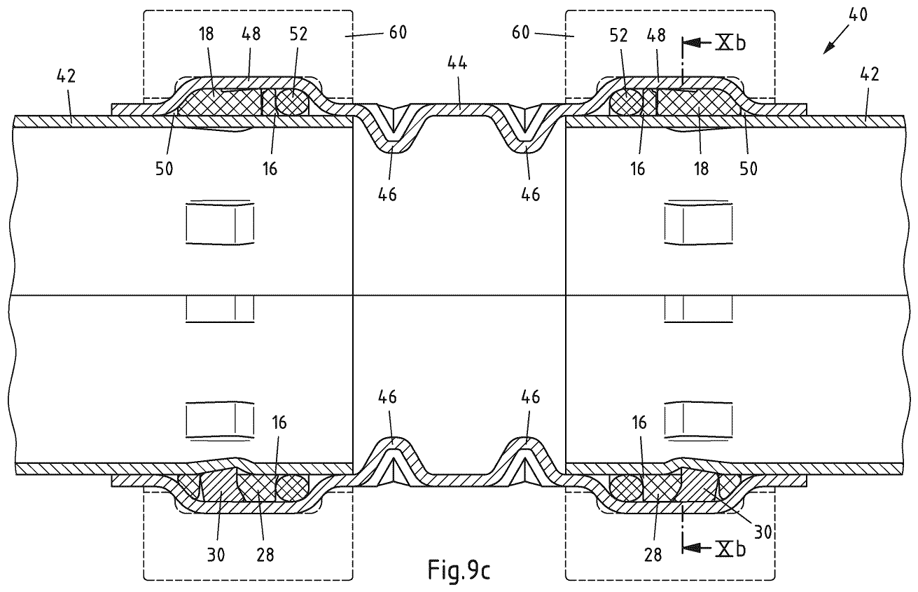

FIGS. 9a to 9c show an embodiment example of a fitting 40 for connection to a pipe 42 to be sealed from the outside. The fitting 40 has a base body 44 and a stop element 46 formed in the base body 44 on the circumference and projecting inwards. Furthermore, a press sleeve 48 is provided which is connected to the base body 44, the press sleeve 48 having a chamber 50 directed inwards towards the pipe 42 to be received.

The clamping ring 2 shown in FIGS. 1a to 4b is arranged in the chamber 50. As described, the clamping ring 2 is made of a plastic and has a plurality of cutting elements 30 aligned against the pull-out direction of the pipe 42 to be inserted. A sealing element 52 is arranged in the chamber 50 adjacent to the stop element 46, which is designed as an O-ring in the present case.

Together with the clamping ring 2, the cutting elements 30 and the sealing element 52, the press sleeve 48 is suitable for sealing and fixing the pipe 42 to be connected from the outside.

FIG. 9a shows the fitting 40 in a cross-section that runs through the retaining elements 18 arranged at the top and bottom of the chamber 50. A retaining element 18 is shown in the cross-section at the top and a fixing element 28 is shown in the cross-section at the bottom. FIG. 9b shows the fitting 40 with inserted pipe 42 in the unpressed state. FIG. 9b shows, as explained above, that the guiding elements 20, 24 and 26 of the retaining element 18 (shown above) hold and centre the pipe 42 during insertion and before pressing. FIG. 9c then shows the fitting 40 in the pressed state, which is produced by the pressing tool 60, whereby the guiding elements 20, 24 and 26 lie closely against the surface of the pipe 42 and thus contribute to fixing and holding the pipe 42.

The functionality of the fixing element 28 is shown in FIGS. 9a to 9c in cross-section below. On the one hand, the protective elements 32 protect the surface of the pipe 42 from damage by the cutting elements 30 during insertion and in the unpressed state, as FIG. 9b shows. On the other hand, the integrated cutting elements 30 have penetrated into the material of the pipe 42 after pressing as shown in FIG. 9c and fix the pipe 42 in the fitting 40.

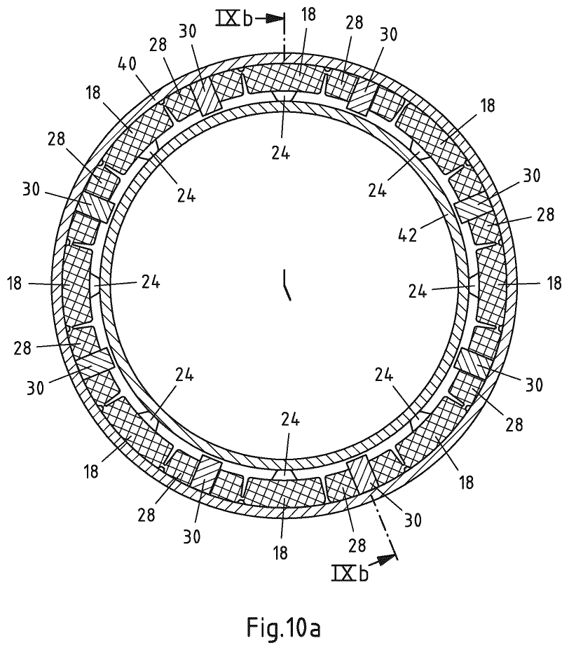

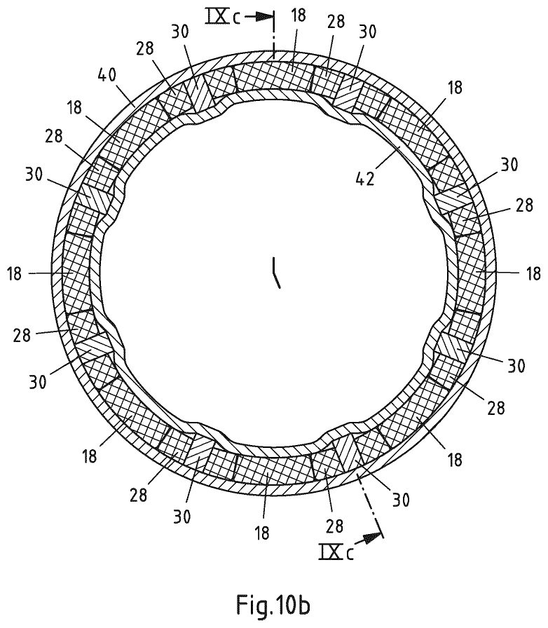

FIGS. 10a and 10b each show a cross-section of the fitting 40 in the area of the press sleeve 48 with chamber 50. In the unpressed state shown in FIG. 10a, the clamping ring 2 is arranged inside the chamber 50 and the ring elements 4 in the form of alternating retaining elements 18 and fixing elements 28 are located on the inside of the chamber 50. The guiding elements 20 are located on the outside of the pipe 42, while the cutting elements 30 are arranged at a distance from the pipe. This spacing is caused and ensured by the protective elements 32 described above, which are not shown in this cross-section, and also by the guiding elements 20 of the neighbouring retaining elements 18.

FIG. 10b shows the pressed state in which the press sleeve 48 has been formed radially inwards by a pressing tool 60 not shown here, see FIG. 9c with dashed lines. The reduction in diameter leads on the one hand to a reduction in the distance between the retaining elements 18 and the fixing elements 28, which now lie against each other, and on the other hand to the penetration of the cutting elements 30 into the wall of the double-layer pipe 42, which is thus deformed radially inwards. This fixes the pipe 42 within the fitting 40 and secures it against being pulled out or pushed out and against axial rotation.

1-11. (canceled)

12. A clamping ring for a fitting for a pipe to be sealed from the outside,
with a plurality of ring elements,
with a plurality of hinge elements for the pivotable connection of two ring elements in each case and
wherein the ring elements are designed to hold and/or fix a pipe to be inserted,
wherein the ring elements have a strip shape by means of the hinge elements and
the ring elements can have a flat shape or a laterally open ring shape, wherein
the ring elements have lateral surfaces in the azimuthal direction, which are designed to taper inwards towards each other at least in sections in the radial direction.

13. The clamping ring according to claim 12, wherein
the ring elements have a partially cylindrical outer surface.

14. The clamping ring according to claim 12, wherein
the ring elements have a predetermined azimuthal length, so that by cutting the strip of hinge elements into strips with at least two different numbers of ring elements for at least two clamping rings for fittings with at least two different standard widths is possible.

15. The clamping ring according to claim 12, wherein
the ring elements have a seal seat at the end facing a seal to be inserted.

16. The clamping ring according to claim 12, wherein
the ring elements are at least partially designed as retaining elements, and
the retaining elements have radially inwardly directed, preferably elastically designed guiding elements for centring and, if necessary, holding a pipe to be inserted.

17. The clamping ring according to claim 16, wherein
at least two guiding elements projecting radially inwards to different extents are formed one behind the other in the axial direction.

18. The clamping ring according to claim 12, wherein
the ring elements are at least partially designed as fixing elements, and
the fixing elements each have at least one cutting element for fixing a pipe to be inserted.

19. The clamping ring according to claim 18, wherein
the fixing elements have protective elements arranged next to the cutting elements in the circumferential direction, the protective elements projecting further inwards in the radial direction than the cutting elements.

20. The clamping ring according to claim 12, wherein
some of the ring elements are designed as retaining elements and some of the ring elements are designed as fixing elements.

21. A fitting for connecting to a pipe to be sealed from the outside,
with a base body,
with a stop element formed in the base body on the circumference and projecting inwards,
with a press sleeve connected to the base body, wherein the press sleeve has a chamber directed inwards towards the pipe to be received,
with a clamping ring arranged in the chamber, the clamping ring consisting of a plastic and having a plurality of cutting elements aligned counter to the direction in which the pipe to be inserted is pulled out, and
with a sealing element arranged in the chamber adjacent to the stop element,
wherein the press sleeve is suitable, together with the clamping ring, the cutting elements and the sealing element, for sealing the pipe to be connected from the outside, wherein
the clamping ring is designed according to claim 12.
